(19) United States
(12) Patent Application Publication
(10) Pub. No.: US 2005/0202778 A1
(43) Pub. Date: Sep. 15, 2005

(54) Wall-mounted exhaust vents

(76) Inventor: David M. Stravitz, New York, NY (US)

Correspondence Address: FRISHAUF, HOLTZ, GOODMAN & CHICK, PC, 220 5TH AVE FL 16, NEW YORK, NY, 10001-7708, US

(21) Appl. No.: 10/798,059

(22) Filed: Mar. 11, 2004

(51) Int. Cl. B60H 1/34

(52) U.S. Cl. 454/353; 34/235

(57) ABSTRACT

Vent for a duct terminating proximate a wall with a self-leveling feature. The vent includes a first member connectable to the wall in engagement with the duct, a second member rotatably connected to and at least partially in front of the first member and at least one flap pivotally mounted to the second member. Upon rotation of the second member relative to the first member, a pivot axis of each flap is adjustable, e.g., to provide a horizontal pivot axis. Thus, even though the first member is first mounted to the wall, the second member is rotatable relative thereto and this relative rotation enables the orientation or pivot axis of the flap(s) to be adjustable. Accordingly, the first member can be mounted to the wall without concern as to how the flap(s) will be oriented.

### FIELD OF THE INVENTION

The present invention relates in general to vents for enabling a one-way flow of air from a duct leading from an interior of a structure to a location outside of the structure and more specifically to exhaust vents for mounting to an exterior wall of a structure to provide a one-way flow of exhaust air from a vent member receiving the exhaust air from a clothes dryer to a location exterior of the structure.

The present invention also relates to self-leveling exhaust vents which include one or more flaps which are rotatable to provide a horizontal axis after connection of the vent to a structure.

The present invention also relates to general air flow vents which provide control over both the flow and direction of an air stream therethrough.

### BACKGROUND OF THE INVENTION

The exhaust from a clothes dryer is typically routed to the outside atmosphere by means of a flexible conduit and some type of vent. The exit location from the corresponding structure is typically an outside wall of the structure or a window panel with the glass pane removed. The flexible conduit is secured to the exhaust conduit of the clothes dryer and then routed to the exit location and optionally connected to a rigid conduit. At the exit location, a flow opening or passageway is created in the structure wall or window panel and a suitable vent is mounted into, onto or across the exit flow opening.

In order to substantially prevent the inflow or backflow of outside air, as well as to prevent the entry of moisture which may be due to rain or snow, exhaust vents of this type may be covered with a hood and often include a one-way or hinged flap or a series of hinged flaps secured within a surrounding frame.

When installing the exhaust vent, it is preferred that the flaps pivot about horizontal axes. In this manner, the flaps will reliably return to a down state when the exhaust air flow through the vent ceases. Otherwise, if mounted in a different orientation, the flaps will not reliably and repeatedly close when the exhaust air flow ceases, i.e., when the clothes dryer has completed the drying cycle.

Accordingly, installation of exhaust vents involves a leveling process wherein the flaps are mounted to pivot about horizontal axes.

It is often a problem to level exhaust vents since the flaps are fixed relative to the portion of the exhaust vent mounted to the structure, e.g,, a mounting flange. Thus, in order to ensure that the flaps will pivot about horizontal axes, care must be taken when attaching the mounting flange to the structure. Often though, such care is not exercised and the exhaust vent must either be remounted or the flaps are maintained in a non-ideal orientation.

### OBJECTS AND SUMMARY OF THE INVENTION

It is an object of the present invention to provide new and improved vents for enabling a one-way flow of air from a duct leading from an interior of a structure to a location outside of the structure.

It is another object of the present invention to provide new and improved exhaust vents for mounting to an exterior wall of a structure to provide a one-way flow of exhaust air from a vent member receiving the exhaust air from a clothes dryer to a location exterior of the structure.

It is yet another object of the present invention to provide exhaust vents which are self-leveling in that they can be leveled to cause one or more flaps thereof to pivot about horizontal axes regardless of the manner and orientation in which the vents are attached to a structure.

Accordingly, to achieve these objects and others, one embodiment of a vent for a duct terminating proximate a wall of a structure in accordance with the invention includes a first member adapted to be connectable to the wall in engagement with the duct, a second member rotatably connected to the first member and adapted to be arranged in front of the wall and at least one flap pivotally mounted to the second member such that upon rotation of the second member relative to the first member, a pivot axis of each flap is adjustable, e.g., to provide a horizontal pivot axis. The flap or flaps cover an opening at the end of the duct. In this manner, even though the first member is mounted to the wall, usually fixed to the wall, the second member is rotatable relative thereto and this relative rotation enables the orientation or pivot axis of the flap(s) to be adjustable. Accordingly, the first member can be mounted to the wall without concern as to how the flap(s) will be oriented. This self-leveling feature greatly simplifies the installation of the vent.

The first member may be a mounting flange including an attachment mechanism for enabling its attachment to the wall and/or the duct. For example, the mounting flange may include an annular wall or portion which lies flush against the inner or outer surface of the wall and includes holes through which screws can be drilled into the wall. Another attachment mechanism constitutes coaxial cylindrical walls formed on a rear side of the mounting flange with a clearance therebetween designed to snugly accommodate the terminal end of the duct.

The second member may be a trim flange which covers the mounting flange and has decorative trim thereon. The trim flange may include a connecting mechanism for rotatably connecting it to the mounting flange. For example, the connecting mechanism might be flexible snap fingers arranged on a substantially cylindrical wall of the trim flange to engage with a cylindrical wall of the mounting flange.

In another embodiment, the second member serves as a cover having a defined interior in which the flap(s) is/are situated and includes openings for the air flow therethrough. Such a cover prevents small animals from entering into the duct through the vent when the flap(s) are open. The mounting flange may be connected to the cover member by flexible snap fingers arranged on a rim of the mounting flange to engage with and secure a rim of the cover member. As the number of flaps is increased (and the length of each flap is thereby reduced), it becomes possible to reduce the depth of the cover member.

Another embodiment of a vent for a duct terminating proximate a wall in accordance with the invention includes a mounting flange adapted to be connectable to the wall in engagement with the duct, a sleeve member rotatably connected to the mounting flange, a lint grill connected to the sleeve member and adapted to extend across the opening of the duct, a flap plate frame pressed against the wall by the sleeve member such that the flap plate frame is rotatable relative to the sleeve member until the sleeve member is tightly engaged with the mounting flange and a flap pivotally mounted to the flap plate frame. With this structure, upon rotation of the flap plate frame prior to tight engagement of the sleeve member with the mounting flange, a pivot axis of the flap is adjustable, e.g., to provide the flap with a horizontal pivot axis.

The sleeve member may be removably connected to the mounting flange by arranging cooperating threads on an inner surface of the mounting flange and on an outer surface of the sleeve member. Coarse threads may be provided to reduce the number of turns required to thread the sleeve member into the mounting flange.

To enable the flap plate frame to be pressed against the wall upon rotation of the sleeve member into the mounting flange, the sleeve member includes a peripheral, outwardly directed rim formed at a front edge and the flap plate frame includes an annular seat for receiving the peripheral rim.

Another embodiment of a vent for a duct terminating proximate a wall in accordance with the invention includes a mounting flange adapted to be engaged with the duct, a trim flange engaged with the mounting flange including at least one disc portion having openings and a rotary disc rotatably mounted to each disc portion of the trim flange. Each rotary disc is rotatable relative to the trim flange to vary correspondence between openings in the rotary disc and the openings in the respective disc portion of the trim flange and thereby vary flow through the vent.

This vent thus provides controlled flow obtained by rotating the rotary discs relative to the trim flange. The rotary discs also include parallel vanes to enable the vent to control the direction of the flow of air therethrough.

The trim flange includes a cylindrical wall arranged in engagement with a cylindrical wall of the mounting flange to secure the trim flange to the mounting flange. Specifically, the trim flange includes a center axle, spokes extending inward from a rear, peripheral edge of the cylindrical wall thereof to the center axle and a spring arm attached to each spoke. The spring arms exert pressure against the cylindrical wall of the mounting flange when the trim flange is engaged with the mounting flange.

Other and further objects, advantages and features of the present invention will be understood by reference to the following specification in conjunction with the annexed drawings, wherein like parts have been given like numbers.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a perspective view of a first embodiment of an exhaust vent in accordance with the invention.

FIG. 2 is a cross-sectional view taken along the line 2-2 of FIG. 1.

FIG. 3 is a front elevational view of the exhaust vent shown in FIG. 1.

FIG. 4 is an exploded perspective view of the exhaust vent shown in FIG. 1.

FIG. 5 is a perspective view of a second embodiment of an exhaust vent in accordance with the invention.

FIG. 6 is a cross-sectional view taken along the line 6-6 of FIG. 5.

FIG. 7 is a cross-sectional front view taken along the line 7-7 of FIG. 6.

FIG. 8 is an exploded perspective view of the exhaust vent shown in FIG. 5.

FIG. 9 is a perspective view of a third embodiment of an exhaust vent in accordance with the invention.

FIG. 10 is a cross-sectional view taken along the line 10-10 of FIG. 9.

FIG. 11 is a cross-sectional front view taken along the line 11-11 of FIG. 10.

FIG. 12 is an exploded perspective view of the exhaust vent shown in FIG. 9.

FIG. 13 is a perspective view of a fourth embodiment of an exhaust vent in accordance with the invention.

FIG. 14 is a cross-sectional view taken along the line 14-14 of FIG. 13.

FIG. 15 is a front elevational view of the exhaust vent shown in FIG. 13.

FIG. 16 is an exploded perspective view of the exhaust vent shown in FIG. 13.

FIG. 17 is a perspective view of a fifth embodiment of an exhaust vent in accordance with the invention.

FIG. 18 is an exploded perspective view of the exhaust vent shown in FIG. 17.

FIG. 19 is a perspective view of a sixth embodiment of an exhaust vent in accordance with the invention.

FIG. 20 is a cross-sectional side view taken along the line 20-20 of FIG. 19.

FIG. 21 is a rear elevational view of the exhaust vent shown in FIG. 19.

FIG. 22 is an exploded perspective view of the exhaust vent shown in FIG. 19.

FIG. 23 is a perspective view of a seventh embodiment of an exhaust vent in accordance with the invention.

FIG. 24 is a cross-sectional view taken along the line 24-24 of FIG. 23.

### DETAILED DESCRIPTION OF THE INVENTION

Referring to the accompanying drawings wherein like reference numerals refer to the same or similar elements, a first embodiment of an exhaust vent in accordance with the invention is shown in FIGS. 1-4 and designated generally as 10. The exhaust vent 10 is designed to engage with an open end of a duct 6 arranged in an aperture of a wall 8 of an exterior structure. For example, the exhaust vent 10 may be used to terminate a vent member arranged in an aperture of an exterior wall of a house and coupled at its inner end to a vent conduit leading from a clothes dryer. However, it is conceivable that the wall 8 may be an inside wall of a building and thus, the term “exterior structure” is used herein to designate any structure exterior to an exhaust gas generating device whereby it is desired to vent the exhaust gas from the generating device to another space exterior to or outside of the space in which the generating device is situated.

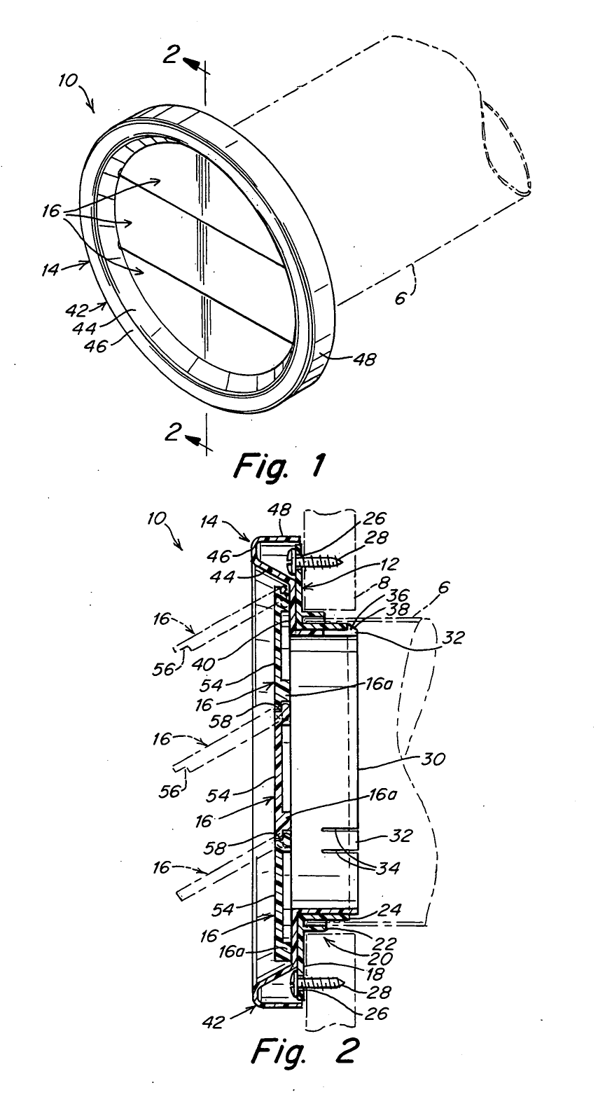

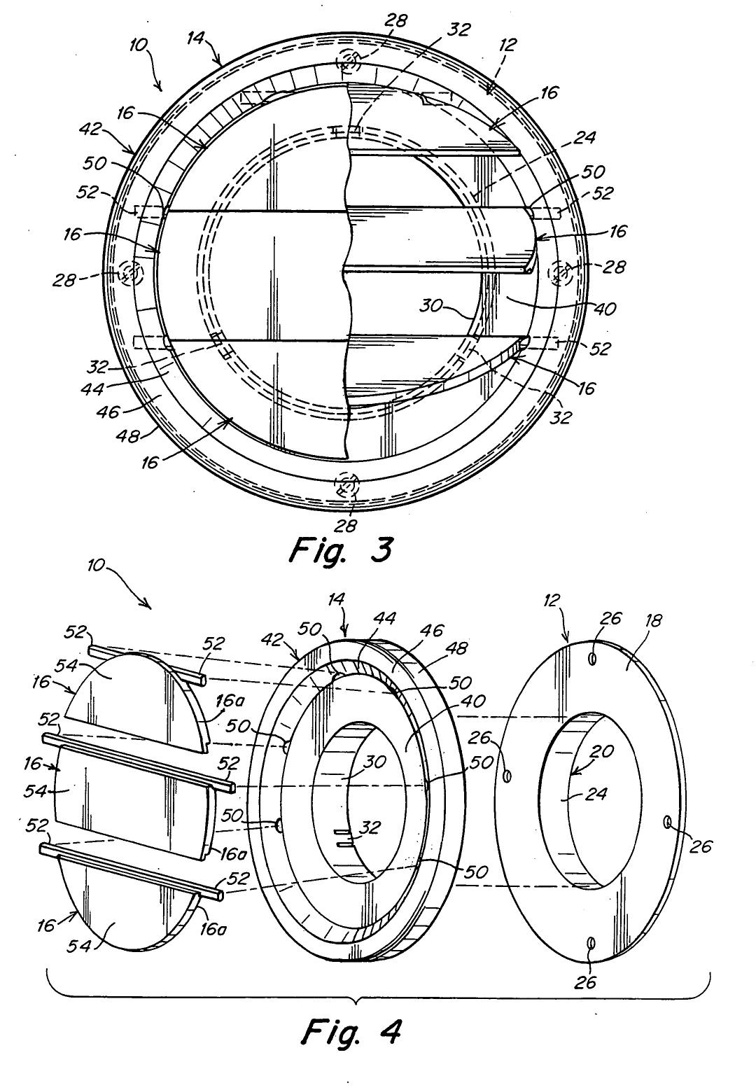

The vent 10 includes a mounting flange 12 which is connected to the wall 8, a trim flange 14 connected to the mounting flange 12 and flaps 16 pivotally mounted on or to the trim flange 14. Flaps 16 have a closed position in which they cover the opening of the duct 6 (see the left side of FIG. 3) and an open position in which they are pivoted outward to allow an air flow through the vent 10 (see the right side of FIG. 3). An open position of the flaps 16 is also shown by the phantom lines in FIG. 2. The pivotal movement of the flaps 16 to the open position is caused by the air flow through the duct 6 which exerts pressure against the flaps 16 and causes the flaps 16 to pivot upward and outward and allow the air flow through the vent 10. When the air flow through the duct 6 ceases, the flaps 16 return to their closed position by the effect of gravity. The flaps 16 will also tend to pivot upward and downward upon variations in the air flow through the duct 6.

Mounting flange 12 includes an annular portion 18 which is designed to be positioned against the wall 8, preferably in contact therewith, and an engagement portion 20 which engages with the open end of the duct 6. Engagement portion 20 includes an outer substantially cylindrical wall 22 and a larger inner substantially cylindrical wall 24 defining a gap therebetween which receives the duct 6 (see FIG. 2).

An attachment mechanism is provided to attach the mounting flange 12 to the wall 8. The attachment mechanism may comprise one or more apertures 26 formed in the annular portion 18 and screws 28 which are passed through the apertures 26 into the wall 8 (see FIG. 2). Alternative attachment mechanisms are also envisioned, such as nails which can be nailed through the annular portion 18 into the wall 8.

Trim flange 14 is connected to the mounting flange 12 so that the trim flange 14 can be rotated, after engagement with the mounting flange 12, until the flaps 16 are positioned in a position in which they pivot about horizontal axes. To this end, the trim flange 12 includes a cylindrical portion 30 having flexible snap fingers 32 which secure the trim flange 14 to the mounting flange 12 yet allow rotation of the trim flange 14 relative to the mounting flange 12. Specifically, the cylindrical portion 30 of the trim flange 14 is designed to fit in an opening defined by the inner cylindrical wall 24 of the mounting flange 12 with the snap fingers 32 engaging a rear edge of the inner cylindrical wall 24 (see FIG. 2).

Flexible snap fingers 32 are formed by providing two axial cuts 34 in the cylindrical portion 30 and an outwardly directed projection 36 between the cuts 34 (see FIG. 2). Each projection 36 may have an angled front surface 38 to facilitate insertion of the cylindrical portion 30 into the opening defined by the inner cylindrical wall 24 of the mounting flange 12 and passage therethrough (see FIG. 2). In one embodiment, three flexible snap fingers 32 are provided and spaced equiangularly about the cylindrical portion 30. Instead of snap fingers 32, other mechanisms for enabling rotation of the trim flange 14 relative to the mounting flange 12 may also be provided, including those disclosed in other embodiments herein to the extent possible.

Trim flange 14 also includes an annular portion 40 extending from an outer edge of the cylindrical portion 30 and arranged against the annular portion 18 of the mounting flange 12 and a rim 42 surrounding the annular portion 40. Rim 42 includes an inner wall 44 angled outward from the annular portion 40, an annular wall 46 connected to an outer edge thereof and a cylindrical outer wall 48 connected to the outer edge of the annular wall 46. The annular portion 40 and rim 42 are preferably dimensioned to overlie and cover the mounting flange 12 such that the mounting flange 12 is not visible from the front of the vent 10 (see FIG. 1). The entire trim flange 14 may be formed of an integral member.

To mount the flaps 16 to the trim flange 14, the inner wall 44 of the rim 42 include pairs of opposite recesses 50, one pair for each flap 16, and each flap 16 includes a pair of mounting projections 52 extending from a substantially planar body 54 and which are insertable into a respective pair of recesses 50 in the inner wall 44. The projections 52 and body 54 are slightly bendable so that the flaps 16 can be bent in order to force the projections 52 into the recesses 50. Instead of mounting projections 52, each flap 16 can include a elongate pin with the ends of the pin constituting the mounting projections.

The projections 52 are rotatable in the recesses 50 to enable the flaps 16 to pivot about pivot axes defined by the projections 52. Since the pivot axes are preferably parallel to one another, the pairs of recesses 50 are formed such that lines extending through the pairs of recesses 50 are parallel to one another. Thus, the flaps 16 can all pivot about horizontal axes when the trim flange 14 is properly positioned.

In the illustrated embodiment, the flaps 16 are designed to completely close the open end of the duct 6. To this end, an upper edge of the uppermost flap 16, side edges of the intermediate flap 16 and a lower edge of the lowermost flap 16 extend beyond the opening of the duct 6. Also, the uppermost flap 16 is mounted to pivot about an axis defined entirely alongside the annular portion 40, and thus this pivot axis will be situated above the top of the opening of the duct 6. Adjoining edges of the flaps 16 are then designed to engage with one another, e.g., in the form of a half lap joint with a notch 56 being formed at the lower edge of the uppermost and intermediate flaps 16 and a complementary notch 58 being formed at the upper edge of the intermediate and lowermost flaps 16 (see FIGS. 2 and 4). When the flaps 16 are closed, the notches 56 engage notches 58 thereby providing an efficient closure of the duct 6.

In addition, each flap 16 includes a peripheral rim 16a extending from a rear surface and which is arranged to contact the annular portion 40 of the trim flange 14 (see FIG. 2).

To install the vent 10, the first step is to attach the mounting flange 12 to the wall 8. Attachment of the mounting flange 12 to the wall 8 involves positioning the mounting flange 12 such that the duct 6 is received in the gap between cylindrical walls 22 and 24 and then drilling the screws 28 through apertures 26 into the wall 8. When attaching the mounting flange 12 to the wall 8, consideration does not have to be given to the orientation of the mounting flange 12 relative to the duct 6 to ensure that the flaps 16 pivot about horizontal axes since the flaps 16 are not fixed in place based on the orientation of the mounting flange 12.

The next step is to connect the trim flange 14 to the mounting flange 12 by inserting the cylindrical portion 30 of the trim flange 14 into the opening defined by the inner cylindrical wall 24 of the mounting flange 12. During this insertion, the snap fingers 32 flex inward as the angled front surfaces 38 thereof initially contact the inner cylindrical wall 24 and then slide along the inner surface of the inner cylindrical wall 24. At the inner axial end of the inner cylindrical wall 24, the snap fingers 32 snap outward to thereby secure the trim flange 14 to the mounting flange 12. Removal of the trim flange 14 from engagement with the mounting flange 12 is prevented by the engagement of the projections 36 of the snap fingers against the rear edge of the inner cylindrical wall 24. However, the projections 36 are rotatable along the rear edge of the inner cylindrical wall 24 so that the trim flange 14 is rotatable relative to the mounting flange 12.

The flaps 16 may be snapped into the trim flange 14 by pressing the projections 50 of each flap 16 into the respective pair of recesses 48 either before or after the trim flange 14 is connected to the mounting flange 12. When different shaped flaps 16 are used as in the illustrated embodiment, care must be exercised to place each flap 16 in its appropriate position in the trim flange 14.

The final step is to orient the flaps 16 such that they pivot about horizontal axes. This is accomplished by grasping the trim flange 14, e.g., the rim 42 thereof, and rotating it to thereby “level” the flaps 16 and attain the desired position. The flaps 16 will thus pivot outward about horizontal axes upon flow of air through the duct 6 and will reliably return to a position closing the duct 6 when the air flow ceases.

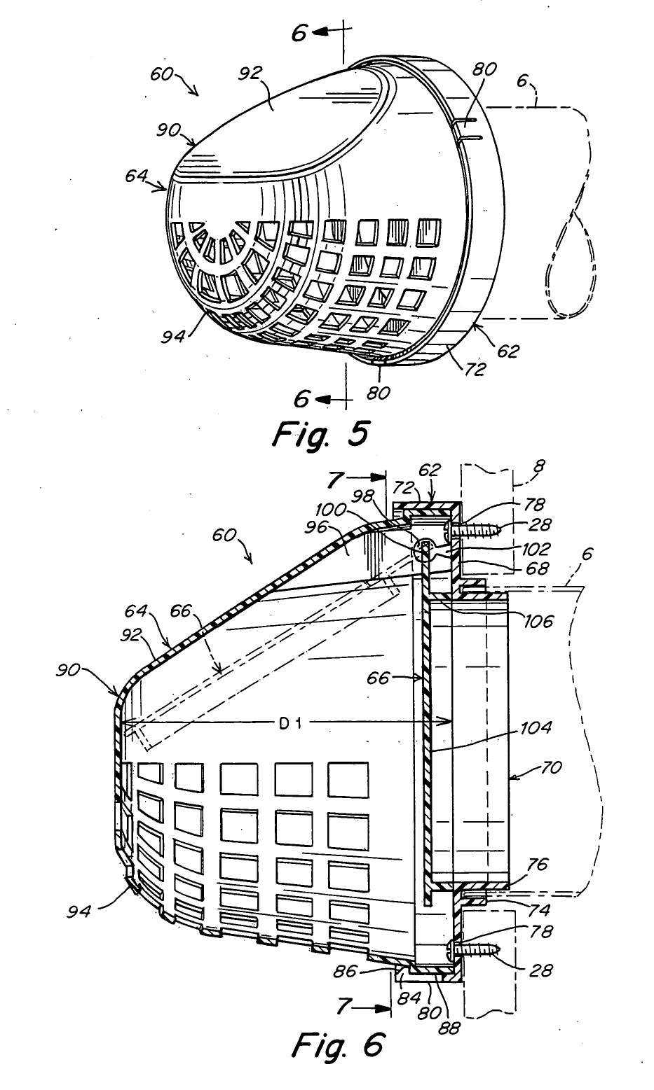

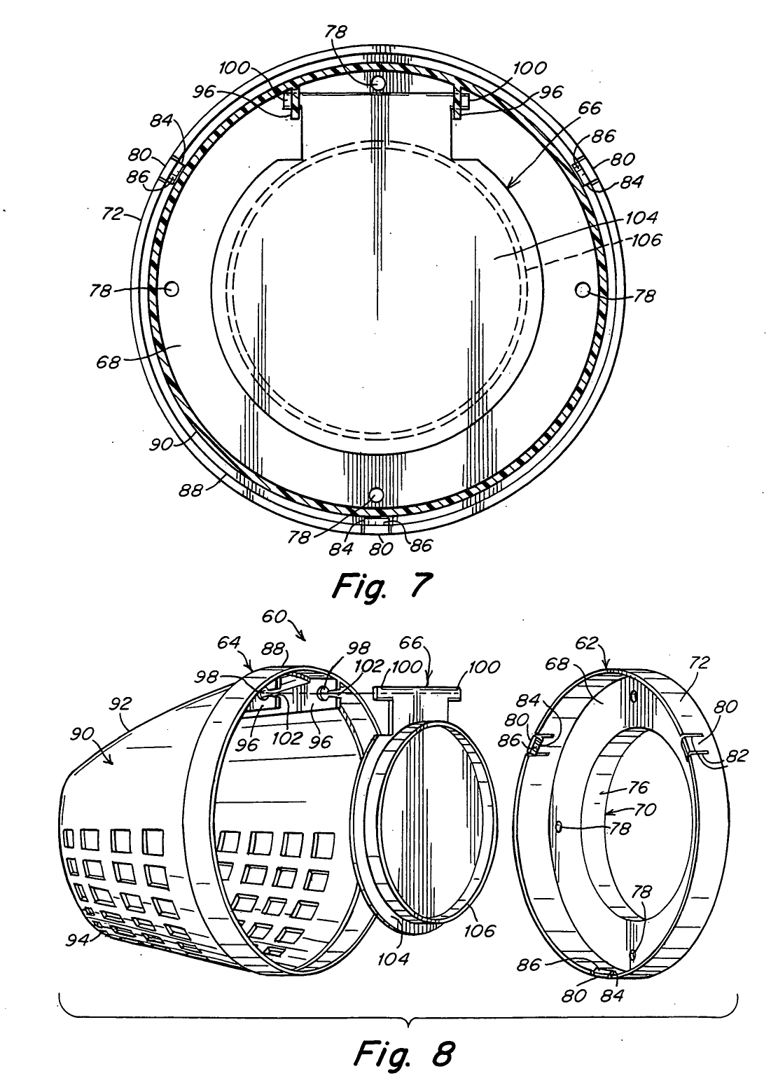

A second embodiment of an exhaust vent in accordance with the invention is shown in FIGS. 5-8 and designated generally as 60. Vent 60 includes a mounting flange 62 which is connected to the wall 8, a cover member 64 connected to the mounting flange 62 and a flap 66 pivotally mounted on the cover member 64. Flap 66 has a closed position in which it covers the opening of the duct 6 (see the flap 66 in solid lines in FIG. 6 and FIG. 7) and an open position in which it is pivoted outward to allow flow of air through the vent 60 (see the flap 66 in phantom lines in FIG. 6). The air flow through the duct 6 exerts pressure against the flap 66 and causes it to pivot outward and allow the air flow through the vent 60. When the air flow through the duct 6 ceases, the flap 66 returns to its closed position by the effect of gravity.

Mounting flange 62 includes an annular portion 68 which is designed to be positioned against the wall 8, preferably in contact therewith, an engagement portion 70 which engages with the end of the duct 6, and a rim 72 which is connectable with the cover member 64. Engagement portion 70 includes an outer cylindrical wall 74 and a larger inner cylindrical wall 76 defining a gap therebetween which receives the duct. 6 (see FIG. 6).

An attachment mechanism is provided to attach the mounting flange 62 to the wall 8, for example, apertures 78 formed in the annular portion 68 and screws 28 which are passed through the apertures 78 into the wall 8 (see FIG. 6). Alternative attachment mechanisms are also envisioned, such as nails which can be nailed through the annular portion 68 into the wall 8.

Rim 72 is substantially cylindrical and includes flexible snap fingers 80 which secure the cover member 64 to the mounting flange 62 yet allow rotation of the cover member 64 relative to the mounting flange 62. Cover member 64 is thus rotatably connected to the mounting flange 62. In this manner, once the mounting flange 62 is secured to the wall 8, the cover member 64 can be connected to the mounting flange 62 with the flap 66 in any orientation and then the cover member 64 rotated to position and “level” the flap 66 until the flap 66 is in a position in which it will pivot about a horizontal axis.

Each snap finger 80 is formed by providing two axial cuts 82 in the rim 72 and an outwardly directed projection 84 between the cuts 82 (see FIG. 8). Each projection 84 preferably includes an angled front surface 86 to facilitate insertion of the cover member 64 into engagement with the mounting flange 62 (see FIG. 6). In one embodiment, three snap fingers 80 are provided and spaced equiangularly about the rim 72 (see FIG. 8). Instead of snap fingers 80, other mechanisms for coupling the cover member 64 to the mounting flange 62 while enabling rotation of the cover member 64 relative to the mounting flange 62 may also be provided, including those disclosed in other embodiments herein to the extent possible.

Cover member 64 includes an engagement rim 88 arranged to be secured by the snap fingers 80 between the snap fingers 82 and the annular portion 68 of the mounting flange 62, and a hood portion 90 having an upper closed section 92 and a lower apertured section 94 to allow air flow therethrough. The hood portion 90 limits the outward pivoting of the flap 66. The shape of the hood portion 90 and the relative position and size of the closed section 92 and apertured section 94 (and apertures thereof) may vary depending on the particular design desired.

Cover member 64 also includes mounting brackets 96 which define holes 98 which receive pins 100 of the flap 66 and slots 102 leading into the holes 98. Pins 100 are inserted into the holes 98 through slots 102 prior to connection of the cover member 64 to the mounting flange 62.

Flap 66 includes a substantially planar body 104 defining the pins 100 and a cylindrical spacing projection 106 arranged on a rear surface of the body 104. When the flap 66 is in a position in which the opening of the duct 6 is closed, the spacing projection 106 abuts against the annular portion 68 of the mounting flange 62 (see FIG. 6).

To install the vent 60, the first step is to attach the mounting flange 62 to the wall 8. This involves positioning the mounting flange 62 such that the duct 6 is received in the gap between cylindrical walls 72 and 74 and then drilling the screws 28 through apertures 78 in the annular portion 68 of the mounting flange 62 into the wall 8. When attaching the mounting flange 62 to the wall 8, consideration does not have to be given to the orientation of the mounting flange 62 relative to the duct 6 to ensure that the flap 66 pivots about a horizontal axis since the flap 66 is connected to the trim flange 64 which is rotatable relative to the mounting flange 62.

If the flap 66 is not previously attached to the cover member 64, then it is now attached by rotating the flap 66 ninety degrees from the position shown in FIG. 8 such that the pins 100 can be inserted through the slots 102 into the holes 98 in the mounting brackets 96. Once the pins 100 are situated in the holes 98, the flap 66 is rotated into a position in which it hangs on the mounting brackets 96, i.e., in a position in which the body 104 is perpendicular to a central axis of the cover member 64 as shown most clearly in FIG. 6.

The next step is to connect the cover member 64, with the attached flap 66, to the mounting flange 62 by inserting the engagement rim 88 of the cover member 64 into engagement with the mounting flange 62. During this insertion, the snap fingers 80 flex outward as the angled front surfaces 86 thereof are contacted by the engagement rim 88 of the cover member 64. The snap fingers 80 slide along the outer surface of the engagement rim 88 until, at the outer axial end of the engagement rim 88, the snap fingers 80 snap inward to thereby secure the rim 88 in connection with the mounting flange 62 (see FIGS. 6 and 7). However, since the snap fingers 80 only prevent separation of the engagement rim 88 from the rim 72 of the mounting flange 62 and not rotation thereof, the cover member 64 is rotatable relative to the mounting flange 62.

The final step in the installation procedure is to orient the flap 66 such that it pivots about a horizontal axis. This is accomplished by grasping the cover member 64, e.g., the hood portion 90 thereof, and rotating it to thereby “level” the flap 66 and attain the desired orientation in which the flap 66 pivots about a horizontal axis. The flap 66 will thus pivot outward upon flow of air through the duct 6 and will reliably return to a position closing the opening of the duct 6 when the air flow ceases.

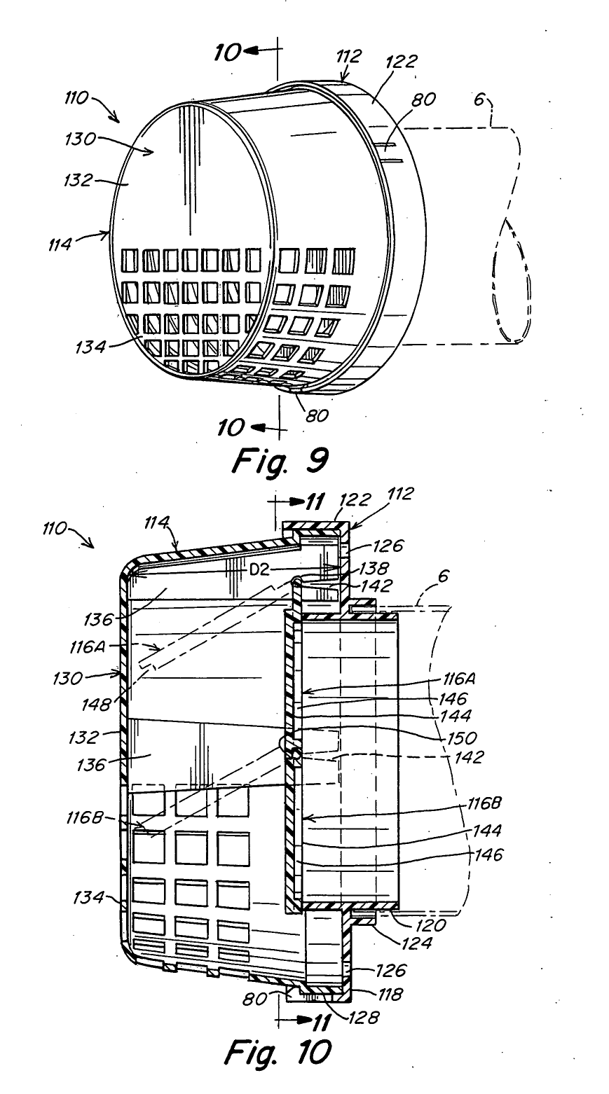

A third embodiment of an exhaust vent in accordance with the invention is shown in FIGS. 9-12 and designated generally as 110. Vent 110 includes a mounting flange 112 which is connected to the wall 8, a cover member 114 connected to the mounting flange 112 and flaps 116A, 116B pivotally mounted to the cover member 114. Flaps 116A, 116B have a closed position in which they cover the opening of the duct 6 (see the flaps 116A, 116B in solid lines in FIG. 10 and FIG. 11) and an open position in which they are pivoted outward to allow air flow through the vent 110 (see the flaps 116A, 116B in phantom lines in FIG. 10). An air flow through the duct 6 exerts pressure against the flaps 116A, 116B and causes them to pivot outward and allow the air flow through the vent 110. When the air flow through the duct 6 ceases, the flaps 116A, 116B return to their closed position by the effect of gravity.

Mounting flange 112 includes an annular portion 118 which is designed to be positioned against the wall 8, preferably in contact therewith, an inner cylindrical wall 120 extending to both sides of the annular portion 118 and a rim 122 which is connectable to the cover member 114. An outer cylindrical wall 124 is arranged around the inner wall 120 on a rear side of the annular portion 118. The inner and outer walls 120, 124 define a gap therebetween which engages with and receives the end of the duct 6 (see FIG. 10).

An attachment mechanism is provided to attach the mounting flange 112 to the wall 8, for example, apertures 126 formed in the annular portion 118 and screws which are passed through the apertures 126 into the wall 8. Alternative attachment mechanisms are also envisioned.

Rim 122 is substantially cylindrical and includes flexible snap fingers 80, described above. Cover member 114 is rotatably connected to the mounting flange 112 via the snap fingers 80 so that once the mounting flange 112 is secured to the wall 8, the cover member 114 can be rotated to level the flaps 116A, 116B, i.e., to position the flaps 116A, 116B in a position in which they pivot about horizontal axes. Instead of snap fingers 80, other mechanisms for enabling rotation of the cover member 114 relative to the mounting flange 112 may also be provided, including those disclosed in other embodiments herein to the extent possible.

Cover member 114 includes an engagement rim 128 arranged to be secured by the snap fingers 80 between the snap fingers 80 and the annular portion 118 of the mounting flange 112, and a hood portion 130 having an upper closed section 132 and a lower apertured section 134 to allow air flow therethrough. The hood portion 130 limits the outward pivoting of the flaps 116A, 116B. The shape of the hood portion 130 and the relative position and size of the closed section 132 and apertured section 134 (including the apertures thereof) may vary depending on the particular design desired.

In contrast to the embodiment shown in FIGS. 5-8, in this embodiment, there are two flaps 116A, 116B instead of a single flap 66 so that the size of each flap 116A, 116B is approximately half the size of the flap 66 (for the same size duct 6). Therefore, since the extension of the flaps 116A, 116B when pivoted outward is less than the extension of the flap 66 when pivoted outward, a reduced clearance in the interior of the hood portion 130 is required to allow the flaps 116A, 116B to open fully. The hood portion 130 can therefore be designed with a lower depth than the depth of the hood portion 90 (D2<D1). Generally, as the number of flaps increases, the extension of each flap when pivoted outward decreases so that a hood portion with a lower depth can be provided (for the same size duct 6).

Cover member 114 also includes pairs of mounting brackets 136 which define holes 138 which receive cylindrical pins 140 of the flaps 116A, 116B and slots 142 leading into the holes 138. The slots 142 on the mounting brackets 136 of the cover member 114 are formed to enable insertion of the pins 140 of the flaps 116A, 116B into the holes 138 prior to connection of the cover member 114 to the mounting flange 112.

Reinforcing ribs 152 are arranged between the mounting brackets 136 and the lateral sides of the hood portion 130 of the cover member 114 to reinforce the mounting brackets 136 when they are apart from the lateral sides of the hood portion 130.

Each flap 116A, 116B includes a substantially planar body 144 with the pins 140 projecting outward to sides of the body 144. A recess 146 is formed on the rear surface of the body 144. When each flap 116A, 116B is in a position in which the opening of the duct 6 is closed, the body 144 abuts against the cylindrical wall 120 of the mounting flange 112 (see FIG. 10).

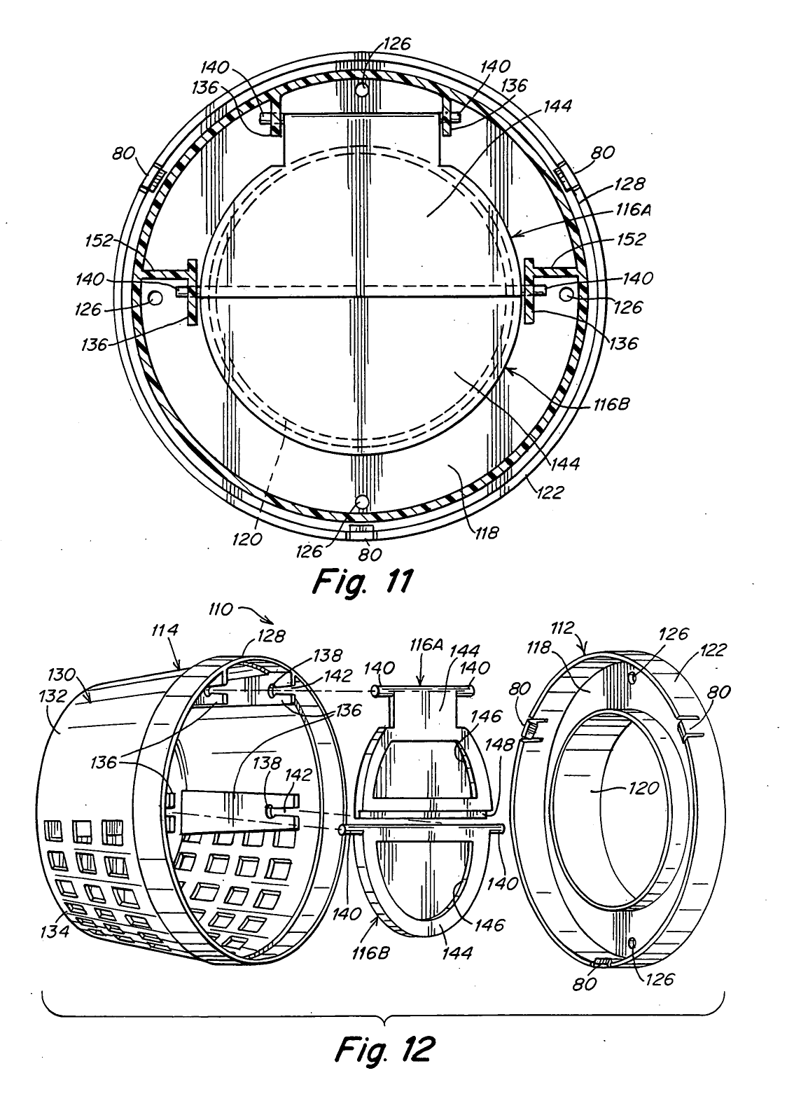

In the illustrated embodiment, the flaps 116A, 116B are designed to completely close the open end of the duct 6. To this end, an upper edge of the flap 116A, side edges of the flaps 116A, 116B and a lower edge of the flap 116B extend beyond the opening defined by the cylindrical wall 120. Also, adjoining edges of the flaps 116A, 116B are designed to engage with one another, e.g., in the form of a half lap joint with a notch 148 being formed at the lower edge of the flap 116A and a complementary notch 150 being formed at the upper edge of the flap 116B (see FIGS. 10 and 12). When the flaps 116A, 116B are closed, the notch 148 engages notch 150 thereby providing an efficient closure of the duct 6.

In an alternative construction of the flaps 116A, 116B, each flap can comprise an elongate cylindrical portion whose ends constitute the pin 140 and a planar portion which is attached to the cylindrical portion.

To install the vent 110, the first step is to attach the mounting flange 112 to the wall 8. This involves positioning the mounting flange 112 such that the duct 6 is received in the gap between cylindrical walls 120 and 124 and then placing screws through apertures 126 in the annular portion 118 of the mounting flange 112 and screwing or drilling them into the wall 8. When attaching the mounting flange 112 to the wall 8, consideration does not have to be given to the orientation of the mounting flange 112 relative to the duct 6 to ensure that the flaps 116A, 116B pivot about horizontal axes since the flaps 116A, 116B are connected to the trim flange 114 which is rotatable relative to the mounting flange 112.

If the flaps 116A, 116B are not previously attached to the cover member 114, then they are now attached by pushing the pins 140 through the slots 142 into the holes 138 in the respective pair of mounting brackets 136.

The next step is to connect the cover member 114, with the attached flaps 116A, 116B, to the mounting flange 112 by inserting the engagement rim 128 of the cover member 114 into engagement with the mounting flange 112. During this insertion, the snap fingers 80 flex outward as the angled front surfaces 86 thereof are contacted by the engagement rim 128 of the cover member 114. The snap fingers 80 slide along the outer surface of the engagement rim 128 until, at the outer axial end of the engagement rim 128, the snap fingers 80 snap inward to thereby secure the rim 128 in connection with the mounting flange 112 (see FIGS. 10 and 11). However, since the snap fingers 80 only prevent separation of the engagement rim 128 from the rim 122 of the mounting flange 112 and not rotation thereof, the cover member 114 is rotatable relative to the mounting flange 112.

The final step in the installation procedure is to orient the flaps 116A, 116B such that they pivot about horizontal axes. This is accomplished by grasping the cover member 114, e.g., the hood portion 130 thereof, and rotating it to thereby “level” the flaps 116A, 116B and attain the desired orientation in which the flaps 116A, 116B pivot about horizontal axes. The flaps 116A, 116B will thus pivot outward upon flow of air through the duct 6 and will reliably return to a position closing the opening of the duct 6 when the air flow ceases.

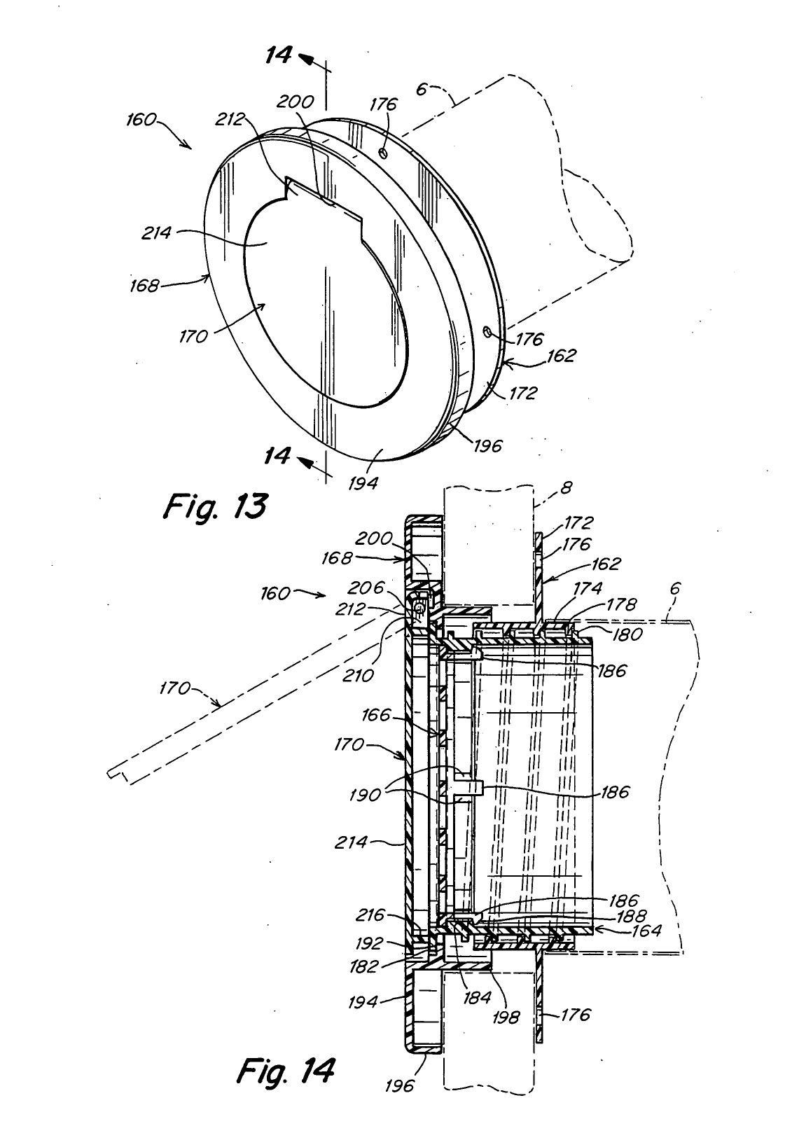

A fourth embodiment of an exhaust vent in accordance with the invention is shown in FIGS. 13-16 and designated generally as 160. This embodiment of the vent 160 differs generally from the embodiments described above in that the mounting flange is mounted to an inner side of the wall 8.

Vent 160 includes a mounting flange 162 which is connected to the wall 8, a generally cylindrical sleeve member 164 removably connected to the mounting flange 162, a lint grill 166 connected to the sleeve member 164 and adapted to extend across the opening of the duct 6, a flap plate frame 168 which is pressed against the wall 8 by the sleeve member 164 and a flap 170 pivotally mounted to the flap plate frame 168. Flap 170 has a closed position in which it covers the lint grill 166 (see the flap 168 in solid lines in FIG. 14) and an open position in which it is pivoted outward to allow air flow through the lint grill 166 (see the flap 170 in phantom lines in FIG. 14). An air flow through the duct 6 and lint grill 166 exerts pressure against the flap 170 and causes it to pivot outward and allow the air flow through the vent 160. When the air flow through the duct 6 ceases, the flap 170 returns to its closed position by the effect of gravity.

Mounting flange 162 includes an annular portion 172 which is designed to be positioned against an inner surface of the wall 8, preferably in contact therewith, and a cylindrical wall 174 extending to both sides of the annular portion 172. Cylindrical wall 174 is dimensioned to fit within the open end of the duct 6, preferably with as small a clearance as possible. Since the annular portion 172 is preferably flush against the inner surface of the wall 8, the duct 6 terminated by the vent 160 does not pass through the aperture in the wall 8. Optionally, a second cylindrical wall can be formed around the cylindrical wall 174 on a rear side of the annular portion 172 to define a gap therebetween which engages with and receives the end of the duct 6 (in the same manner as described above).

An attachment mechanism is provided to attach the mounting flange 162 to the wall 8, for example, apertures 176 formed in the annular portion 172 and screws which are passed through the apertures 176 into the wall 8. Alternative attachment mechanisms are also envisioned.

Another attachment mechanism is provided to enable the sleeve member 164 to be removably attached to the mounting flange 162. Specifically, threads 178 are formed on an inner surface of the cylindrical wall 174 and engage with threads 180 formed on an outer surface of the sleeve member 164 (see FIG. 14). Thus, once the mounting flange 162 is fixed to the wall 8, the sleeve member 164 is rotatable relative thereto in view of the cooperating threads 178, 180. Threads 178, 180 may be a coarse screw thread connection.

The sleeve member 164 also includes a peripheral, outwardly directed rim 182 formed at a front edge and a circumferential raised portion 184 formed on an inner surface proximate the peripheral rim 182.

To connect the lint grill 166 to the sleeve member 164, the lint grill 166 includes flexible snap fingers 186 extending rearward from a rear surface which snap around the raised portion 184 of the sleeve member 164. Each snap finger 186 includes an angled rearward facing surface 188 to facilitate passage of the lint grill 166 over the raised portion 184 of the sleeve member 164 (see FIG. 14). In the illustrated embodiment, four snap fingers 186 are provided spaced equiangularly around the circumference of the lint grill 166. However, any number of snap fingers 186 may be provided and other mechanisms for attaching the lint grill 166 to the sleeve member 164 are also possible.

Anti-rotation lugs 190 are formed on the raised portion 184 of the sleeve member 164 with each snap finger 186 being received between a pair of lugs 190. In view of the positioning of the snap fingers 186 between the lugs 190, rotation of the lint grill 166 causes rotation of the sleeve member 164. The lint grill 166 is more easily rotatable since the installer can insert his or her fingers into the apertures in the lint grill 166 and rotate the lint grill 166 which causes rotation of the sleeve member 164. By contrast, rotation of the sleeve member 164 directly is more difficult since the peripheral rim 182 must be grasped and rotated.

To secure the flap plate frame 168 to the outer surface of the wall 8, the flap plate frame 168 includes an annular seat 192 in which the peripheral rim 182 of the sleeve member 164 is received (see FIG. 14). The flap plate frame 168 is thus pressed against the outer surface of the wall 8 as the sleeve member 164 is rotated into the mounting flange 162.

The flap plate frame 168 also includes an annular wall 194 surrounding the seat 192, a rim 196 extending rearward from an outer circumferential edge of the annular wall 194 and a cylindrical wall 198 extending inward from an inner edge of the annular wall 194. Cylindrical wall 198 is arranged around the seat 192 and is adapted to be positioned in the aperture defined by the wall 8 (see FIG. 14). The sleeve member 164 is arranged in the cylindrical wall 198.

To mount the flap 170 to the flap plate frame 168, a cavity 200 is formed in the annular wall 194 and is defined by opposed walls 202 with each wall 202 including an aperture 204. A pin 206 is passed through apertures 208 in side walls 210 of a mounting portion 212 of the flap 170 and positioned into the apertures 204 to thereby pivotally mount the flap 170 to the flap plate frame 168.

Flap 170 includes a substantially planar body 214 with the mounting portion 212 extending on one side thereof and a cylindrical spacing projection 216 arranged on a rear surface of the body 214. When the flap 170 is in a position in which the opening of the duct 6 is closed, the spacing projection 216 abuts against the peripheral rim 182 of the sleeve member 164 (see FIG. 14).

To install the vent 160, the mounting flange 162 is attached to the wall 8. This involves positioning the mounting flange 162 such that the cylindrical wall 174 is received inside the duct 6, positioning the mounting flange 162 against an inner surface of the wall 8 and then placing screws through apertures 176 in the annular portion 172 of the mounting flange 162 and screwing or drilling them into the wall 8.

The lint grill 166 is then attached to the sleeve member 164 by pushing the snap fingers 182 between the lugs 190. The flap frame plate 168 is then positioned against the outer surface of the wall 8 with its cylindrical wall 198 around the cylindrical wall 174 of the mounting flange 162. Sleeve member 164 is passed through the cylindrical wall 198 of the flap plate frame 168 and rotated into connection with the mounting flange 162 via the cooperating threads 178, 180. At this time, the peripheral rim 182 of the sleeve member 162 is situated in the seat 192 of the flap plate frame 168. Rotation of the sleeve member 164 may be facilitated by inserting fingers through the apertures in the lint grill 166 and rotating the lint grill 166.

If the flap 170 is not previously attached to the flap plate frame 168, then it is now attached by inserting the pin 206 through the apertures 208 in the side walls 210 of the mounting portion 212 and then urging the pin 206 into the apertures 204 in the side walls 202 in the flap plate frame 168.

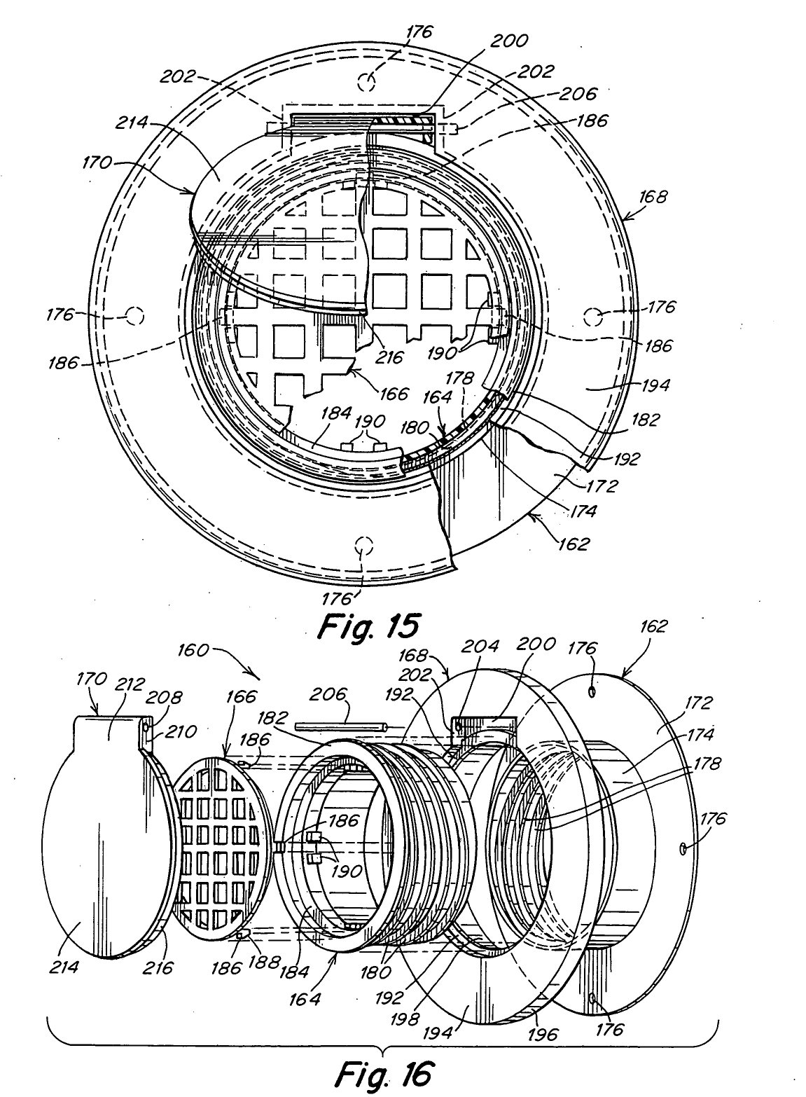

The next step in the installation procedure is to orient the flap 170 such that it pivots about a horizontal axis. This is accomplished by grasping the flap plate frame 168 or flap 170 and holding it such that pin 206 is parallel to a horizontal surface. At the same time, rotation of the sleeve member 164 into engagement with the mounting flange 162 is completed to thereby tightly secure the sleeve member 164 to the mounting flange 162 and the flap plate frame 168 snug against the outer surface of the wall 8. Rotation of the flap plate frame 168 will be prevented since the flap plate frame 168 is pressed against the wall 8 by the sleeve member 164, i.e., sandwiched between the sleeve member 164 and the wall 8. Proper placement of the lugs 190 will result in the lint grill 168 being situated at the orientation shown in FIG. 15.

In this embodiment, the lint grill 166 may be removable by disengaging it from the sleeve member 164 without affecting the remaining mounting connections, to enable a variety of lint grills 166 to be used, e.g., a lint grill with a fine mesh or a lint grill with a coarse mesh.

Alternatively, it is possible to form the lint grill 166 and sleeve member 164 as an integral unit, i.e., as a one-piece construction.

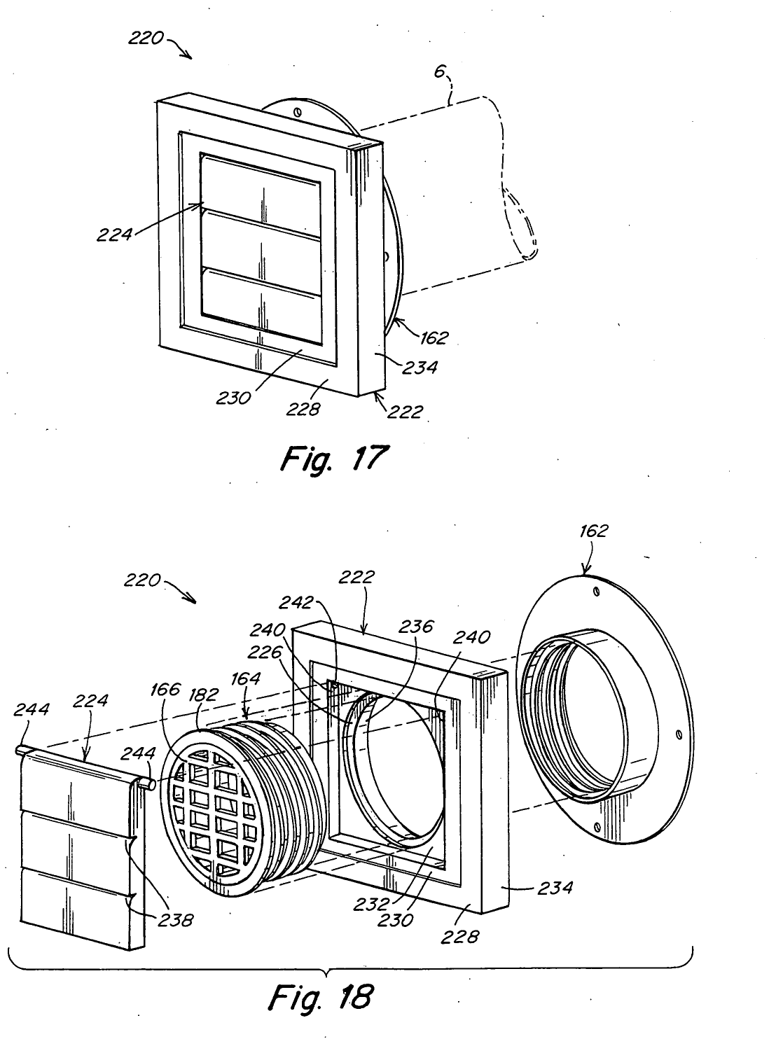

Another embodiment of an exhaust vent in accordance with the invention is shown in FIGS. 17 and 18 and designated generally as 220. This embodiment of the vent 220 differs from the embodiment shown in FIGS. 13-16 in that the flap and flap plate frame are shaped differently. However, the same reference numerals of the embodiment shown in FIGS. 13-16 will be used for the same elements in the embodiment shown in FIGS. 17 and 18. Thus, the vent 220 includes the mounting flange 162, sleeve member 164 and lint grill 166 as described above.

Vent 220 also includes a flap plate frame 222 which is pressed against the wall 8 by the sleeve member 164 and a flap 224 pivotally mounted to the flap plate frame 222. To secure the flap plate frame 222 against the outer surface of the wall 8, the flap plate frame 222 includes an annular seat 226 in which the peripheral rim 182 of the sleeve member 164 is received. The flap plate frame 222 is thus pressed against the outer surface of the wall 8 as the sleeve member 164 is rotated into the mounting flange 162.

The flap plate frame 168 includes a rectangular, peripheral wall 228 including two rectangular depressions 230, 232, a rim 234 extending rearward from an outer circumferential edge of the rectangular wall 228 (on all four sides of the rectangular wall 228), and a cylindrical wall 236 extending inward from an inner edge of the rectangular wall 228. Cylindrical wall 228 is arranged around the seat 226 and is adapted to be positioned in the aperture defined by the wall 8. The sleeve member 164 is arranged in the cylindrical wall 228.

The formation of the depressions 230 on the rectangular wall 228 is substantially for decoration purposes only and various other decorative designs can be formed on the rectangular wall 228. However, the innermost depression 232 is designed to accommodate the flap 224 so that the depression 232 should have the same shape as the flap 224. In addition, the shape of the flap plate frame 222 as a rectangle can be varied, i.e., the flap plate frame 228 can be in the shape of an oval, a square and other geometric shapes. Thus, in an alternative construction, an oval flap plate frame can be formed with an oval depression and used with an oval flap.

The flap 224 also has a decorative form including lateral channels 238 defining three sections. Any number of channels 238 can be formed on the flap 224.

To mount the flap 224 to the flap plate frame 222, opposed side walls 240 defining the depression 232 are each provided with an aperture 242. Projections 244 are formed on lateral sides of the flap 224 and are positioned in the apertures 242 to thereby pivotally mount the flap 224 to the flap plate frame 222.

Installation of the vent 220 is essentially the same as the installation of vent 160 as described above. However, the flap 224 is engaged with the flap plate frame 222 by urging the projections 244 into the apertures 242 on the side walls 240 defining the depression 232 of the flap plate frame 222. Leveling of the flap 224 can now be performed by leveling the flap plate frame 222.

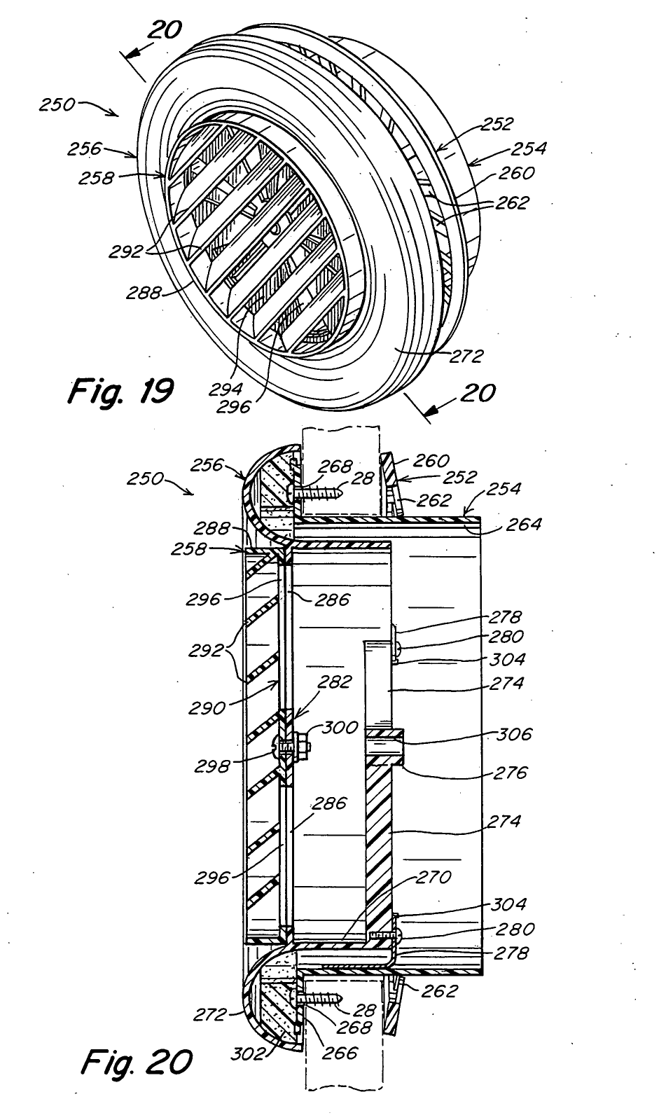

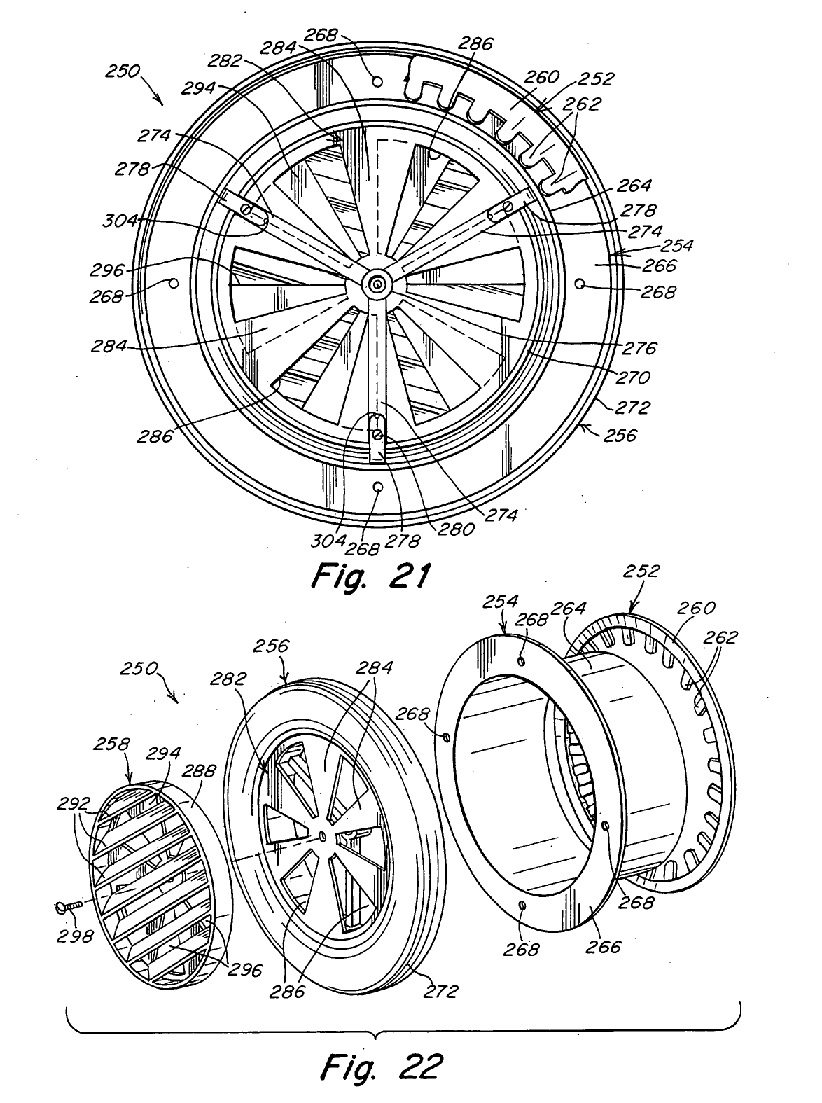

A sixth embodiment of an exhaust vent in accordance with the invention is shown in FIGS. 19-22 and designated generally as 250. This embodiment of the vent 250 provides for control over the flow of air therethrough and direction of the flow of air from the vent 250.

Vent 250 includes a one-way washer 252 adapted to be positioned on an inner side of the wall 8, a mounting flange 254 which passes through the washer 252, a trim flange 256 engaged with the mounting flange 254 and a rotary disc 258 attached to the trim flange 256.

The washer 252 includes an annular portion 260 and a plurality of fingers 262 extending inward from the annular portion 260. The fingers 262 are designed to engage with a cylindrical wall 264 of the mounting flange 254 at an angle to provide a ratcheting effect and prevent removal of the mounting flange 254 after installation of the vent 250.

In addition to the cylindrical wall 264, the mounting flange 254 includes an annular portion 266 extending outward from an outer, peripheral edge of the cylindrical wall 264 and which is designed to be positioned against an outer surface of the wall 8, preferably in contact therewith. Cylindrical wall 264 is dimensioned to fit within the open end of the duct 6, preferably with as small a clearance as possible.

An optional attachment mechanism is provided to attach the mounting flange 254 to the wall 8, for example, apertures 268 are formed in the annular portion 266 and screws can be passed through the apertures 268 into the wall 8. Alternative attachment mechanisms are also envisioned.

Trim flange 256 includes a cylindrical wall 270 and an annular wall 272 having a cross-sectional shape of a semi-circle connected to an outer edge of the cylindrical wall 270. Cylindrical wall 270 is situated in the cylindrical wall 264 of the mounting flange when the vent 250 is assembled. Trim flange 256 also includes three spokes 274 extending inward from a rear, peripheral edge of the cylindrical wall 270 to a center axle 276 and spaced equiangularly around the peripheral edge of the cylindrical wall 270.

To engage the trim flange 256 with the mounting flange 254, a spring arm 278 is attached, e.g., by a screw 280, to the radially outward end of each spoke 274 and the spring arms 278 pressingly contact an inner surface of the cylindrical wall 264 of the mounting flange 254 (See FIG. 20). The spring arms 278 are shaped to allow easy entry of the cylindrical wall 270 of the trim flange 256 into the cylindrical wall 264 of the mounting flange 254. Also, to ensure that the spring arms 278 are placed in appropriate positions to engage with the trim flange 256, a locator pin 304 is arranged on each spoke 274 and the spring arms 278 are positioned to contact the locator pins 304.

Instead of the spring arms 278, alternative mechanisms for engaging the trim flange 256 to the mounting flange 254 can also be used in this embodiment, including those constructions described above. For example, one of the annular portion 266 of the mounting flange 254 and the annular wall 272 of the trim flange 256 could be provided with snap fingers and the other provided with a cooperating structure to engage with the snap fingers to retain the trim flange 256 in connection with the mounting flange 254. In the construction of FIG. 20, when the spring arms 278 are not provided, then it becomes possible to eliminate the spokes 274 and the center axle 276 from the trim flange 256.

Trim flange 256 also includes a disc portion 282 extending across the opening defined by the cylindrical wall 270. Disc portion 282 includes spokes 284 and openings 286 therebetween. The trim flange 256 may be formed as an integral structure.

Rotary disc 258 includes a cylindrical rim 288, a disc portion 290 extending from a rear edge of the rim 288 and a plurality of parallel vanes 292 extending across a space defined by the rim 288. The disc portion 290 includes spokes 294 and openings 296 therebetween.

The rotary disc 258 is attached to the disc portion 282 of the trim flange 254 by an appropriate attachment mechanism such as by inserting a screw 298 through aligning apertures in the disc portion 290 of the rotary disc 258 and the disc portion 282 of the trim flange 254 and threading a nut 300 onto the end of the screw 298 (see FIG. 20). The nut 300 is fastened but not tightened so that rotation of the rotary disc 258 relative to the disc portion 282 is possible.

Alternative attachment mechanism for attaching the rotary disc 258 to the disc portion 282 which enable the rotary disc 258 to rotate relative to the disc portion 282 are also envisioned. For example, the spokes 274 and center axle 276 may be provided to enable a screw to be inserted through the aligning apertures in the rotary disc 258 and the disc portion 282 of the trim flange 256 into engagement with a threaded aperture 306 in the center axle 276. Thus, the spokes 274 and center axle 276 can be provided to support the spring arms 278 and/or enable rotatable attachment of the rotary disc 258 to the trim flange 256. Nevertheless, the spokes 274 and center axle 276 can be eliminated when the spring arms 278 are eliminated and the rotary disc 258 is attached to the trim flange 256 using the screw 298 and nut 300.

A foam rubber ring 302 is arranged inside the annular wall 272 of the trim flange 256 and against the annular portion 266 of the mounting flange 254 when the trim flange 256 is engaged with the mounting flange 254. The ring 302 limits the penetration of the trim flange 256 into the cylindrical wall 264 of the mounting flange 254. The ring 302 may have a cut in it to enable it to be placed in a cavity defined by the annular wall 272 and may also be shaped to conform to the shape of the inner surface of the annular wall 272.

To install the vent 250, the washer 252 is placed around the opening in the wall 8 on an inner side thereof and the cylindrical wall 264 of the mounting flange 254 is passed from the exterior of the wall 8 through the opening therein and into engagement with the washer 252. The fingers 262 on the washer 252 are urged rearward (as shown in FIG. 20) and this inhibits removal of the mounting flange 254 from the wall 8. If a more secure attachment of the mounting flange 254 to the wall 8 is desired, screws can be placed in the apertures 268 in the annular portion 266 of the mounting flange 254 and drilled or screwed through the exterior surface of the wall 8.

The rotary disc 258 is attached to the disc portion 282 of the trim flange 254, e.g., by inserting the screw 298 through aligning apertures in the disc portion 290 of the rotary disc 258 and the disc portion 282 of the trim flange 254 and threading the nut 306 onto the end of the screw 298. The nut 300 is fastened but not tightened so that rotation of the rotary disc 258 relative to the disc portion 282 is possible.

The trim flange 256, with attached rotary disc 258, is then placed into engagement with the mounting flange 254 by inserting the cylindrical wall 270 of the trim flange 256 into the cylindrical wall 264 of the mounting flange 254. The spring arms 278 engage with the cylindrical wall 264 and exert pressure against the cylindrical wall 264 to fix the trim flange 256 in position. In conjunction with this engagement, the ring 302 is placed between the mounting flange 254 and the trim flange 256.

The final step in the installation procedure is to orient the rotary disc 258 to provide the desired flow of air and direction thereof. The rotary disc 258 is rotated relative to the trim flange 256 to vary the correspondence between the openings 296 between the spokes 294 of the rotary disc 258 and the openings 286 between the spokes 286 of the disc portion 282 of the trim flange 256. If the openings 286 and 296 are in complete correspondence, a maximum flow of air will be provided by the vent 250 whereas if the openings 296 of the rotary disc 258 align with the spokes 284 of the disc portion 282, there will not be any flow of air through the vent 250. Between these two extreme positions, any desired position can be selected.

When the rotary disc 258 is rotated, the vanes 292 are also rotated so that the direction of the air flow is also controllable.

In the embodiment illustrated in FIGS. 19-22, there are six spokes 284 on the disc portion 282 of the trim flange 256 and six spokes 294 on the rotary disc 258. However, any number of spokes can be provided.

In addition, the vent 250 can be used for applications other than venting exhaust air, for example, any application in which control of flow and direction of a fluid is desired including but not limited to air-conditioning and heating applications.

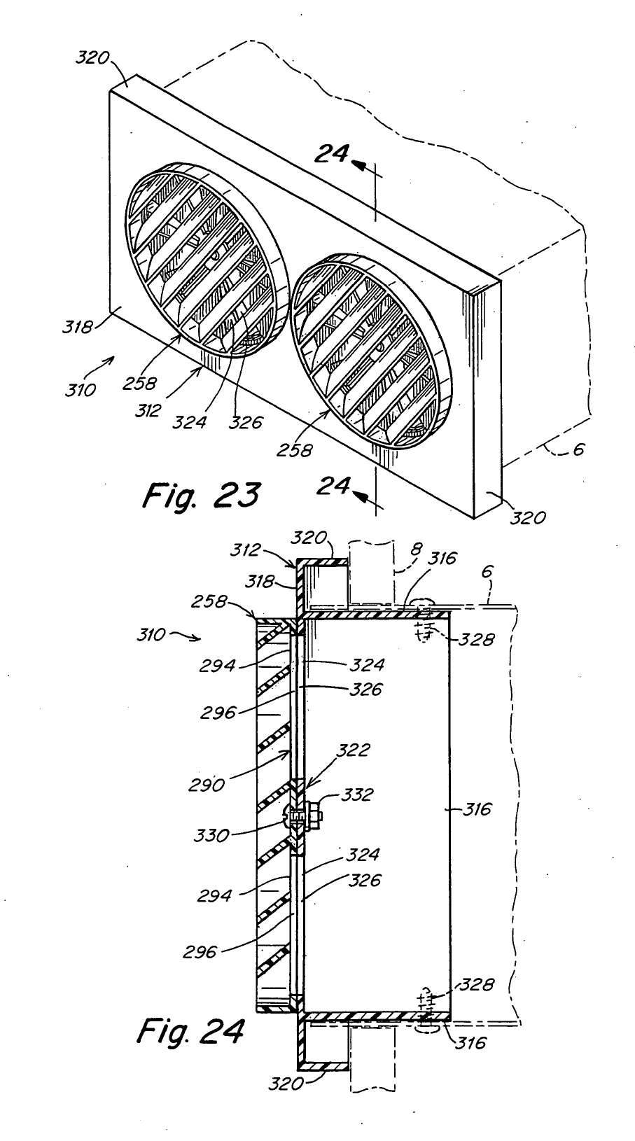

Referring now to FIGS. 23 and 24, another embodiment of a vent in accordance with the invention is designated generally as 310. Vent 310 includes a mounting flange 312 adapted to engage with the duct 6 and two rotary discs 258 (as described above) attached to the mounting flange 312. Mounting flange 312 has a generally rectangular shape and includes inner walls 316, a face plate 318 perpendicular to the inner walls 316 and rim walls 320 extending rearward from the peripheral edges of the face plate 318. Face plate 318 includes two disc portions 322 each having spokes 324 and openings 326 therebetween. For example, each disc portion 322 may have six spokes 324 and six openings 326 therebetween, although any number of spokes 324 is possible.

To secure the mounting flange 312 to the duct 6, screws 328 can be drilled or screwed through the duct into one or more of the inner walls 316 of the mounting flange 312. Alternatively, the mounting flange 312 can be attached to or engage with the duct 6 in any of the ways described above in connection with the other embodiments of the invention or can be attached to the wall 8 in any of the ways described above in connection with the other embodiments of the invention.

The rotary discs 258 are attached to the face plate 318 by an appropriate attachment mechanism such as by inserting a screw 330 through aligning apertures in each rotary disc 258 and a respective disc portion 322 of the face plate 318 and threading a nut 332 onto the end of each screw 330 (see FIG. 24). The nuts 332 are fastened but not tightened so that rotation of the rotary discs 258 relative to the disc portions 322 is possible. Alternative attachment mechanism for attaching the rotary discs 258 to the disc portions 322 which enable the rotary discs 258 to rotate relative to the disc portions 322 are also envisioned.

To install the vent 310, the rotary discs 258 are attached to the disc portions 322 of the face plate 318, e.g., by inserting the screws 330 through aligning apertures in the disc portion 290 of the rotary discs 258 and the disc portions 322 of the face plate 318 and threading the nuts 332 onto the end of the screws 330. Then, the inner walls 316 of the mounting flange 312 are passed through the opening in the wall 8 and into the duct 6 and screws 328 are drilled through the duct 6 into one or more of the inner walls 316.

The final step in the installation procedure is to orient the rotary discs 258 to provide the desired flow of air and direction thereof. The rotary discs 258 are independently rotated relative to the face plate 318 of the mounting flange 312 to vary the correspondence between the openings 296 between the spokes 294 of the rotary discs 258 and the openings 326 between the spokes 324 of the disc portions 322 of the face plate 318. If the openings 296 and 326 are in complete correspondence, a maximum flow of air will be provided by the vent 310 whereas if the openings 296 of the rotary disc 258 align with the spokes 324 of the disc portion 322, there will not be any flow of air through the vent 310. Between these two extreme positions, any desired position can be selected.

Since the rotary discs 258 can be independently rotated, it is possible to have varying degrees of air flow through each rotary disc 258 and provide different flow direction in the same vent 310.

When the rotary discs 258 are rotated, the vanes 292 are also rotated so that the direction of the air flow is also controllable.

The vent 310 can be used for applications other than venting exhaust air, for example, any application in which control of flow and direction of a fluid is desired including but not limited to air-conditioning and heating applications.

While the invention has been described above with respect to specific apparatus and specific implementations, it should be clear that various modifications and alterations can be made, and various features of one embodiment can be included in other embodiments, within the scope of the present invention. For example, mention is made of the use of the vents described above for adjusting the flow of exhaust air from a dryer. It must be appreciated that this use is an exemplifying use of the invention and does not limit the invention in any manner. The invention is considered applicable for other applications in which it is desired to control a fluid flow such as air.

1. A vent for a duct terminating proximate a wall, comprising:
a first member adapted to be connectable to the wall in engagement with the duct;
a second member rotatably connected to said first member and adapted to be arranged in front of the wall; and
at least one flap pivotally mounted to said second member such that upon rotation of said second member relative to said first member, a pivot axis of each of said at least one flap is adjusted.

2. The vent of claim 1, wherein said first member is a mounting flange including attachment means for enabling attachment of said mounting flange to at least one of the wall and the duct.

3. The vent of claim 1, wherein said second member is a trim flange and said at least one flap comprises a plurality of flaps.

4. The vent of claim 1, wherein said second member includes connecting means for rotatably connecting said second member to said first member.

5. The vent of claim 4, wherein said first member includes a cylindrical wall adapted to be coaxial with the duct and said second member includes a cylindrical wall arranged within said cylindrical wall of said first member, said connecting means comprising flexible snap fingers arranged on said cylindrical wall of said second member to engage with said cylindrical wall of said first member.

6. The vent of claim 1, wherein said first member includes an annular portion adapted to abut an outer surface of the wall and a cylindrical wall adapted to be coaxial with the duct, said second member including a cylindrical wall arranged within said cylindrical wall of said first member.

7. The vent of claim 1, wherein said second member includes a cylindrical wall adapted to be arranged partially in the duct, an annular portion extending from an outer edge of said cylindrical wall and abutting said first member and a rim surrounding said annular portion.

8. The vent of claim 7, wherein said at least one flap comprises a plurality of flaps, said rim includes a plurality of pairs of opposite recesses arranged such that a line extending through each of said pairs of recesses is parallel to a line extending through other of said pairs of recesses, said flaps being rotatably mounted in said recesses.

9. The vent of claim 8, wherein each of said flaps includes a planar body and a pair of opposed projections arranged in a respective one of said pairs of recesses, said projections being rotatable in said recesses to thereby enable said flaps to pivot outward relative to said second member about said projections.

10. The vent of claim 1, wherein said second member is a cover member defining an interior in which said at least one flap is pivotable and including openings for air flow from an interior of said cover member to an exterior of said cover member.

11. The vent of claim 10, further comprising connecting means for rotatably connecting said cover member to said first member.

12. The vent of claim 11, wherein said first member includes a rim at an outer periphery and said cover member includes a rim connectable with said rim of said cover member, said connecting means comprising flexible snap fingers arranged on said rim of said first member.

13. The vent of claim 12, wherein said snap fingers consist of three snap fingers spaced equiangularly around said rim of said first member.

14. The vent of claim 10, wherein said first member includes an annular wall adapted to be positioned against an outer surface of the wall, an engagement portion adapted to engage with the duct, and a rim connectable with said cover member.

15. The vent of claim 10, wherein said cover member includes mounting brackets for mounting said at least one flap.

16. The vent of claim 10, wherein said at least one flap consists of a single flap, said single flap including a rim on a rear surface arranged to abut said first member and thereby provide the vent with a closed state.

17. The vent of claim 10, wherein said at least one flap comprises a plurality of flaps.

18. The vent of claim 17, wherein said first member includes a cylindrical wall, said flaps being arranged to abut said cylindrical wall and thereby provide the vent with a closed state.

19. A vent for a duct terminating proximate a wall, comprising:
a mounting flange adapted to be connectable to the wall in engagement with the duct;
a sleeve member rotatably connected to said mounting flange;
a lint grill connected to said sleeve member and adapted to extend across the opening of the duct;
a flap plate frame pressed against the wall by said sleeve member such that said flap plate frame is rotatable relative to said sleeve member until said sleeve member is tightly engaged with said mounting flange; and
a flap pivotally mounted to said flap plate frame such that upon rotation of said flap plate frame prior to tight engagement of said sleeve member with said mounting flange, a pivot axis of said flap is adjustable.

20. The vent of claim 19, wherein said mounting flange includes an annular portion adapted to be positioned against an inner surface of the wall, and a cylindrical wall extending to both sides of said annular portion, said cylindrical wall being arranged to fit within the opening of the duct.

21. The vent of claim 19, further comprising connecting means for removably connecting said sleeve member to said mounting flange.

22. The vent of claim 21, wherein said mounting flange includes a cylindrical wall, said connecting means comprising threads formed on an inner surface of said cylindrical wall of said mounting flange and on an outer surface of said sleeve member.

23. The vent of claim 19, wherein said lint grill is removably connected to said sleeve member.

24. The vent of claim 19, wherein said lint grill and said sleeve member are formed as an integral unit.

25. The vent of claim 19, wherein said sleeve member includes a circumferential raised portion formed on an inner surface, said lint grill including flexible snap fingers for engaging with said raised portion of said sleeve member, said sleeve member including a pair of anti-rotation lugs arranged on both sides of each of said snap fingers to prevent rotation of the lint grill relative to said sleeve member.

26. The vent of claim 19, wherein said sleeve member includes a peripheral, outwardly directed rim formed at a front edge and said flap plate frame includes an annular seat for receiving said peripheral rim such that said seat is pressed by said rim against the wall upon rotation of said sleeve member into said mounting flange.

27. The vent of claim 19, wherein said flap plate frame includes a pair of opposed walls defining a cavity, an aperture being formed in each of said walls, and said flap includes a mounting portion with at least one aperture therein, further comprising a pin extending through said apertures in said walls of said flap plate frame and said at least one aperture of said mounting portion of said flap and defining the pivot axis of said flap.

28. The vent of claim 19, wherein said flap plate frame is substantially rectangular and defines a rectangular depression, said flap being substantially rectangular and being mounted in said depression.

29. The vent of claim 19, wherein said flap plate frame includes opposed walls defining a depression, each of said walls including an apertures, said flap including projections on lateral sides and which are positioned in said apertures in said walls to thereby pivotally mount said flap to said flap plate frame.

30. A vent for a duct terminating proximate a wall, comprising:
a mounting flange adapted to be engaged with the duct;
a trim flange engaged with said mounting flange and adapted to be arranged at least partially in front of the wall, said trim flange including at least one disc portion having openings; and
a rotary disc rotatably mounted to each of said at least one disc portion of said trim flange and including openings, said rotary disc being rotatable relative to said trim flange to vary correspondence between said openings in said rotary disc and said openings in said at least one disc portion of said trim flange and thereby vary flow through said vent.

31. The vent of claim 30, further comprising a one-way washer adapted to be positioned on an inner side of the wall, said mounting flange being arranged to pass through said washer from an outer side of the wall and engage with said washer such that said washer retains said mounting flange in connection with the wall.

32. The vent of claim 31, wherein said washer comprises an annular portion and fingers extending inward from said annular portion, said mounting flange engaging with said fingers.

33. The vent of claim 30, wherein said mounting flange includes a cylindrical wall adapted to be coaxial with the duct, said trim flange including a cylindrical wall arranged in said cylindrical wall of said mounting flange and engagement means for engaging said trim flange with said mounting flange.

34. The vent of claim 33, wherein said engagement means comprise a center axle, spokes extending inward from a rear, peripheral edge of said cylindrical wall to said center axle and a spring arm attached to each spoke and arranged in engagement with said cylindrical wall of said mounting flange when said trim flange is engaged with said mounting flange.

35. The vent of claim 30, wherein said rotary disc includes a cylindrical rim, a disc portion extending from a rear edge of said rim and a plurality of parallel vanes extending across a space defined by said rim, said disc portion of said rotary disc including said openings.

36. The vent of claim 30, further comprising attachment means for attaching said rotary disc to said trim flange.

37. The vent of claim 30, said trim flange includes an annular wall and said mounting flange includes an annular wall, further comprising a foam rubber ring arranged between said annular wall of said trim flange and said annular wall of said mounting flange when said trim flange is engaged with said mounting flange.

38. A vent for a duct terminating proximate a wall, comprising:
a mounting flange adapted to be engaged with the duct, said mounting flange including a plurality of disc portions each having openings; and
a plurality of rotary discs each rotatably mounted to a respective one of said disc portions of said mounting flange and including openings, said rotary discs being rotatable relative to said mounting flange to vary correspondence between said openings in said rotary discs and said openings in said disc portions of said mounting flange and thereby vary flow through said vent.

39. The vent of claim 38, wherein said trim flange has a substantially rectangular shape and said plurality of disc portions consists of two disc portions.

40. The vent of claim 39, wherein said mounting flange includes inner walls adapted to engage with the duct, a face plate perpendicular to said inner walls and rim walls extending rearward from peripheral edges of said face plate, said face plate including said two disc portions.
